(19) United States
(12) Patent Application Publication
(10) Pub. No.: US 2009/0069135 A1
(43) Pub. Date: Mar. 12, 2009

(54) SPROCKET OF BICYCLE WITH SPECIAL DESIGNED TOOTH

(76) Inventor: Douglas CHIANG, Taichung City (TW)

Correspondence Address: Chien-Hui Su, P. O. Box 70-121 Taichung, Taichung City, 40899, TW

(21) Appl. No.: 11/853,843

(22) Filed: Sep. 12, 2007

(51) Int. Cl. B62M 9/10

(52) U.S. Cl. 474/164

(57) ABSTRACT

A sprocket wheel of a bicycle comprises a large sprocket having a plurality of teeth; a small sprocket having a plurality of teeth; and a chain. For each tooth of the large sprocket and small sprocket, a first lateral side of the tooth has a first edge line at a top end thereof; the first lateral side is cut inwards from to form as a notch; the notch is a cambered surface and a lower side of the notch is confined by a second edge line. In assembly, the first lateral side of the large sprocket is placed to be adjacent to a small sprocket so as to reduce interferences and noises in driving. The topside of the tooth has the first edge line and a third edge line; and the topside of the tooth is an inclined to a wheel surfaces.

### FIELD OF THE INVENTION

The present invention relates to bicycle parts, and particularly to a chain wheel of a bicycle, wherein the chain can be changed to a large sprocket from a small sprocket smoothly without noise and interference so that the bicycle can be driven safely and steadily. Furthermore the lifetime of the bicycle is prolonged.

### BACKGROUND OF THE INVENTION

One prior art bicycle sprocket wheel is disclosed in U.S. Pat. No. 4,889,521, in that A multistage sprocket assembly is provided which includes at least one larger diameter sprocket and at least one smaller diameter sprocket assembled in a relationship such that the center point between a pair of adjacent teeth at the larger diameter sprocket and the center point between a pair of adjacent teeth at the smaller diameter sprocket are positioned on a tangent extending along the sprocket path when the sprocket is being shifted from the smaller diameter sprocket to the larger diameter sprocket. The distance between both the center points is equal to an integer multiple of the sprocket pitch. A sprocket guide portion is provided at the inside surface of the larger diameter sprocket and at a position corresponding to a moving path of a driving sprocket traveling between the aforesaid center points for allowing the sprocket to move axially of the sprocket assembly slightly toward the larger diameter sprocket during shifting.

However, although above mentioned structure can provide a compact structure for the change of the sprockets, it generates noise and interference to the sprockets. The noise gives a bad feeling to the driver and the interference will cause unstable driving and the sprockets to be destroyed for a long time.

### SUMMARY OF THE INVENTION

Accordingly, the primary object of the present invention is to provide a chain wheel of a bicycle, wherein the chain can be changed to a large sprocket from a small sprocket smoothly without noise and interference so that the bicycle can be driven safely and steadily. Furthermore the lifetime of the bicycle is prolonged.

To achieve above objects, the present invention provides A sprocket wheel of a bicycle comprising: a large sprocket having a plurality of teeth; a small sprocket having a plurality of teeth; a chain; wherein for each tooth of the large sprocket and small sprocket, a topside of the tooth has a first edge line and a third edge line; the topside of the tooth is an inclined to a wheel surfaces; a first lateral side of the tooth has a first edge line at a top end thereof; the first lateral side is cut inwards from to form as a notch; the notch being formed by two surfaces including a first surface and a second surface; the first surface having the first edge line; the second surface being below the first surface; a connection of the first surface and second surface is as a middle edge line; a lower side of the second surface is confined by a second edge line; and a second lateral side of the tooth is formed by three surfaces including a third surface at a middle side of the three surfaces; the three surfaces of the second lateral side being concave inwards from the surface of the tooth; the third surface being lower than the other surfaces of the second lateral side. In assembly, the first lateral side of the large sprocket is placed to be adjacent to a small sprocket wheel so as to reduce interferences and noises in driving.

The various objects and advantages of the present invention will be more readily understood from the following detailed description when read in conjunction with the appended drawing.

### BRIEF DESCRIPTION OF THE DRAWINGS

FIG. 1 is a front schematic view of the sprocket wheel of a bicycle of the present invention.

FIG. 2 is a front schematic view about the large sprocket wheel of the present invention.

FIG. 3 is a backside schematic view about the large sprocket wheel of the present invention.

FIG. 4A is a schematic view of the tooth of the present invention.

FIG. 4B is a front schematic view about the tooth of the present invention.

FIG. 4C is a lateral schematic view about the tooth of the present invention.

FIG. 4D is a schematic perspective view of the tooth of the present invention.

FIG. 4E is a rear view of the tooth of a bicycle of the present invention.

FIG. 4F is an upper view of the tooth of the present invention.

FIG. 5 shows the operation of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

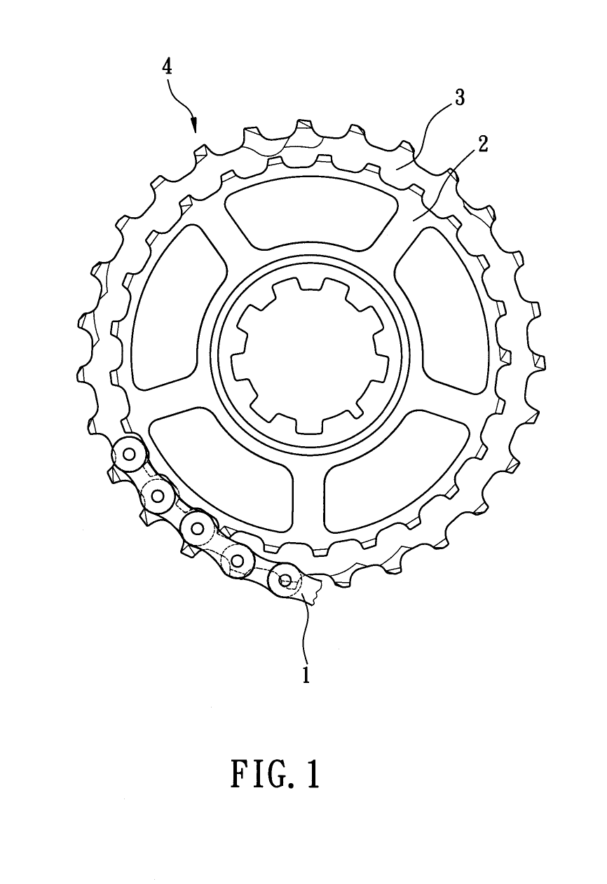

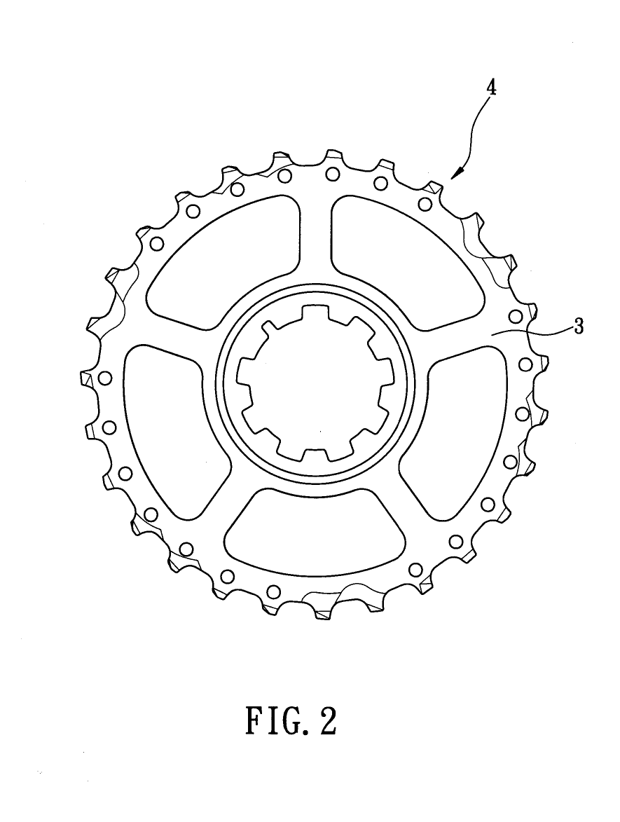

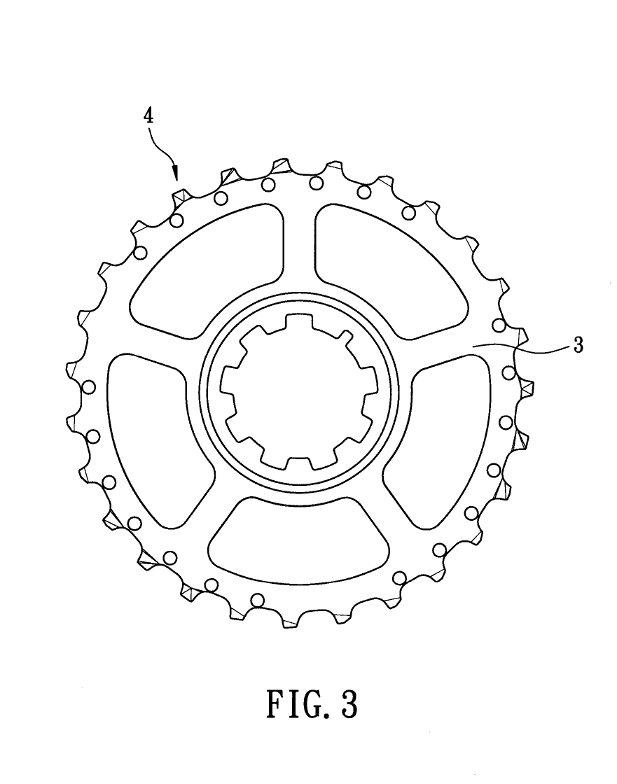

With reference to FIGS. 1 to 4, the structure of the present invention is illustrated. The structure related to the present invention includes a large sprocket 3, a small sprocket 2 and a chain 1.

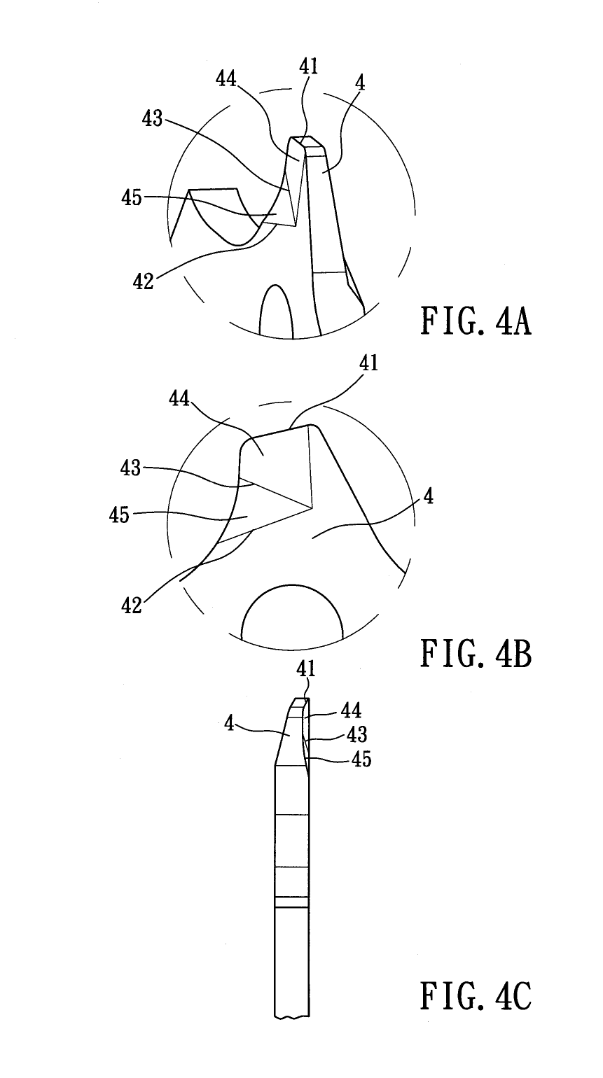

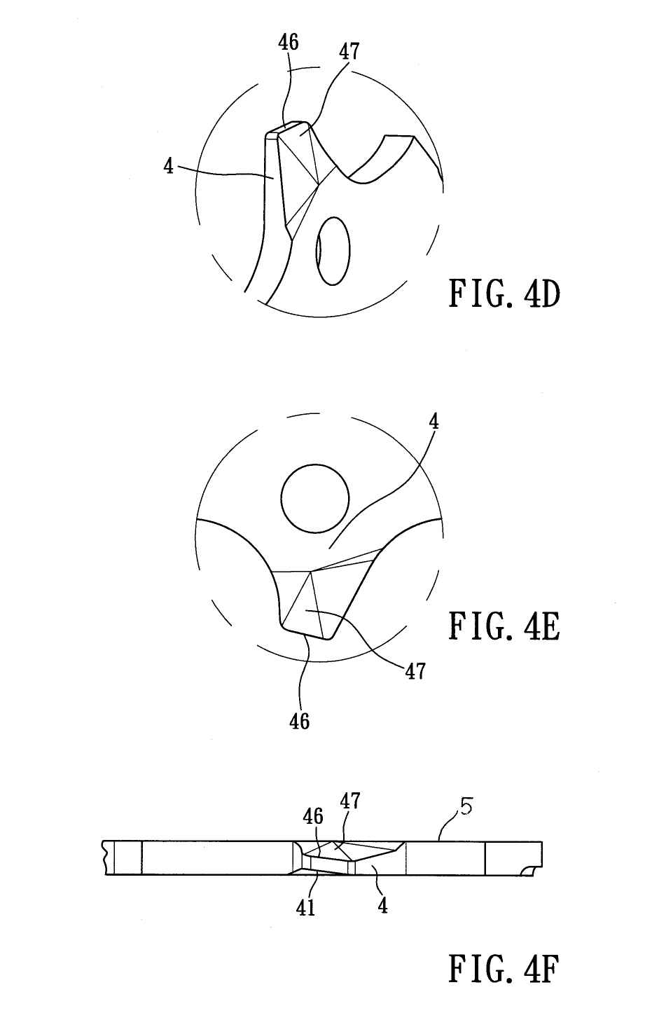

Each of the large sprocket 3 and small sprocket 2 is formed by a plurality of teeth 4. Referring to FIG. 4F, a top view of one tooth 4 is illustrated. In the top view of FIG. 4F, it is illustrated that the topside of the tooth 4 has two approximately parallel edge lines which are a first edge line 41 and a third edge line 46. The topside of the tooth 4 is an inclined to the wheel surfaces 5.

Referring to FIG. 4A, a first lateral side of the tooth 4 is illustrated. The lateral side has a first edge line 41 at a top end thereof. The first lateral side is cut inwards from to form as a notch. The notch is formed by two surfaces including a first surface 44 and a second surface 45. The first surface 44 has the first edge line 41. The second surface 45 is below the first surface 44. The connection of the first surface 44 and second surface 45 is formed as a middle edge line 43. A lower side of the second surface 45 is confined by a second edge line 42.

In the present invention, the first surface 44 and the second surface 45 may be planes or are formed as a smooth concave surface.

Referring to FIG. 4D and FIG. 4F, a second lateral side of the tooth 4 is illustrated. It is illustrated that the second lateral side is formed by three surfaces including a third surface 47 at a middle side of the three surfaces. The three surfaces of the second lateral side are concave inwards from the surface 5 of the wheel. The third surface 47 is lower that the other surfaces of the second lateral side.

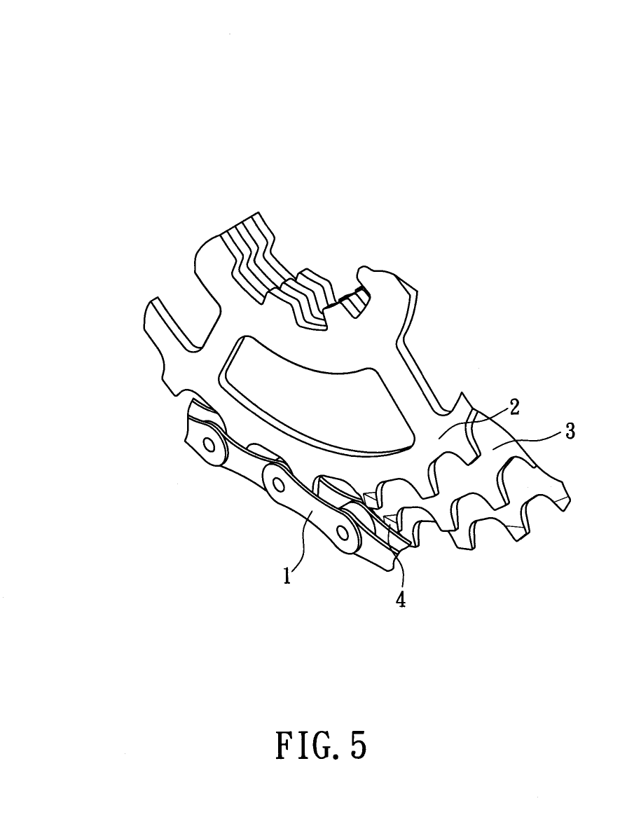

Referring to FIG. 5, the assembly of sprockets of different diameters and the chain 1 are illustrated. In assembly, for each sprocket, the first lateral side of a large sprocket 3 is placed to be adjacent to a small sprocket 2.

In the present invention, it should be noted that the first surface 44 and second surface 45 may be cambered surface or plane and the third surface 47 is a plane.

In the following the operation of the present invention will be described with reference to FIG. 5, when the chain 1 is changed to a large sprocket 3 from a small sprocket 2, initially, most of the chain 1 is at the small sprocket 2 and the first lateral side of the tooth 4 of the large sprocket 3 is adhered to the sprocket 2. The second surface 45 is adhered to a lower portion of the inner side of the chain 1. The second surface 45 will push the chain 1. The chain 1 will not fully place in the second surface 45 of the tooth 4. Since the top end of the tooth 4 is inclined (referring to FIG. 4F), the chain 1 is pushed inwards so that the following tooth 4 of the large sprocket 3 will fall into the chain 1. For a longer time, the whole chain 1 will fall into the large sprocket wheel 1 so as to complete the operation. No interference and no noise generate. At this state, the tooth 4 of the large sprocket 3 inserts into the chain 1 and the third surface 47 is in contact with an inner surface of the chain 1. The inclination of the third surface 47 will make the tooth 4 easily fall into the sprocket 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sprocket wheel of a bicycle, comprising:
a large sprocket having a plurality of teeth;
a small sprocket having a plurality of teeth;
a chain;
wherein for each tooth of the large sprocket and small sprocket, a topside of the tooth has a first edge line and a third edge line; the topside of the tooth is an inclined to a wheel surfaces;
a first lateral side of the tooth has a first edge line at a top end thereof; the first lateral side is cut inwards from to form as a notch; the notch being formed by two surfaces including a first surface and a second surface; the first surface having the first edge line; the second surface being below the first surface; a connection of the first surface and second surface is as a middle edge line; a lower side of the second surface is confined by a second edge line; and
a second lateral side of the tooth is formed by three surfaces including a third surface at a middle side of the three surfaces; the three surfaces of the second lateral side being concave inwards from the surface of the tooth; the third surface being lower than the other surfaces of the second lateral side; and
wherein in assembly, the first lateral side of the large sprocket is placed to be adjacent to a small sprocket wheel so as to reduce interferences and noises in driving.

2. The sprocket wheel of a bicycle as claimed in claim 1, wherein the first surface and second surface are cambered surface or planes.

3. The sprocket wheel of a bicycle as claimed in claim 1, wherein the first edge line is parallel to the third edge line.

4. The sprocket wheel of a bicycle as claimed in claim 1, wherein the third surface is a plane.

5. A sprocket wheel of a bicycle, comprising:
a large sprocket having a plurality of teeth;
a small sprocket having a plurality of teeth;
a chain;
wherein for each tooth of the large sprocket and small sprocket, a first lateral side of the tooth has a first edge line at a top end thereof; the first lateral side is cut inwards from to form as a notch; the notch is a cambered surface and a lower side of the notch is confined by a second edge line; and
wherein in assembly, the first lateral side of the large sprocket is placed to be adjacent to a small sprocket so as to reduce interferences and noises in driving.

6. The sprocket wheel of a bicycle as claimed in claim 5, wherein the topside of the tooth has the first edge line and a third edge line; and the topside of the tooth is an inclined to a wheel surfaces.

7. The sprocket wheel of a bicycle as claimed in claim 5, wherein the first edge line is parallel to the third edge line.
